(19) United States
(12) Patent Application Publication
(10) Pub. No.: US 2014/0075230 A1
(43) Pub. Date: Mar. 13, 2014

(54) Waking An Electronic Device

(71) Applicants: Bradley Neal Suggs, Sunnyvale, CA (US); Robert Campbell, Cupertino, CA (US); Fred Charles Thomas, III, Fort Collins, CO (US)

(72) Inventors: Bradley Neal Suggs, Sunnyvale, CA (US); Robert Campbell, Cupertino, CA (US); Fred Charles Thomas, III, Fort Collins, CO (US)

(21) Appl. No.: 14/110,166

(22) PCT Filed: May 31, 2011
(86) PCT No.: PCT/US11/38522

§ 371 Date: Oct. 7, 2013

(51) Int. Cl. G06F 1/32

(52) U.S. Cl. CPC G06F 1/325
USPC 713/323

(57) ABSTRACT

Implementations disclosed herein relate to waking an electronic device 107. In one embodiment, an electronic device 107 detects a person within a particular proximity of the electronic device 107 and wakes the electronic device 107 while suppressing an outward indication of the operation of the electronic device 107. The electronic device 107 may then detect a person intending to use the electronic device 107 and therefore exhibit the outward indication of the operation of the electronic device 107.

### BACKGROUND

An electronic device may start a wake process to enter an active state from a sleep, suspended, standby, or hibernation state. For example, the electronic device may power peripheral devices, such as a display, speakers, and external drives, and execute software for preparing the electronic device for use. The electronic device may be ready for use when the wake process is complete.

### BRIEF DESCRIPTION OF THE DRAWINGS

The drawings describe example implementations. The drawings show methods performed in an example order, but the methods may also be performed in other orders. The following detailed description references the drawings, wherein:

FIG. 1 is a block diagram illustrating one example of a computing system.

FIG. 2 is a flow chart illustrating one example of a method to wake an electronic device.

FIG. 3 is a flow chart illustrating one example of waking an electronic device.

FIG. 4 is a flow chart illustrating one example of waking an electronic device.

### DETAILED DESCRIPTION

An electronic device may be placed in various modes. For example, an electronic device may be in a reduced power mode, such as asleep, standby, suspend, or hibernation mode. An electronic device in one of these modes may use less power because fewer components of the electronic device may be powered on during more inactive modes. A wake process may involve turning on the additional components such that the electronic device enters a more active awake mode allowing the electronic device to be used. A user may become impatient with the amount of time between pressing a power button or otherwise waking an electronic device and the electronic device becoming available for use.

To address this problem, an electronic device determines that a person is within a particular proximity of the electronic device, such as determining that a person entered a room, and the electronic device begins a wake process while suppressing an outward indication of the wake process. The electronic device may then determine that a person is attempting to use the electronic device, at which point the electronic device may exhibit the outward indication of the wake process. For example, the electronic device may begin a wake process without backlighting a display associated with the electronic device when a person enters a room and backlight the display when the person moves a mouse associated with the electronic device. The electronic device may determine that a person is within a particular proximity of the electronic device or intending to use the electronic device based on information from sensors associated with the electronic device.

Allowing an electronic device to remain in an inactive mode until a person is closer to the electronic device to perform a wake process may conserve power until it is more likely that a person may be using the electronic device soon. Waking an electronic device while making the device appear to remain in an inactive state may cause the electronic device appear to wake and be ready for use more quickly when a person is ready to use the electronic device. This may result in a better perception of a user experience with the electronic device.

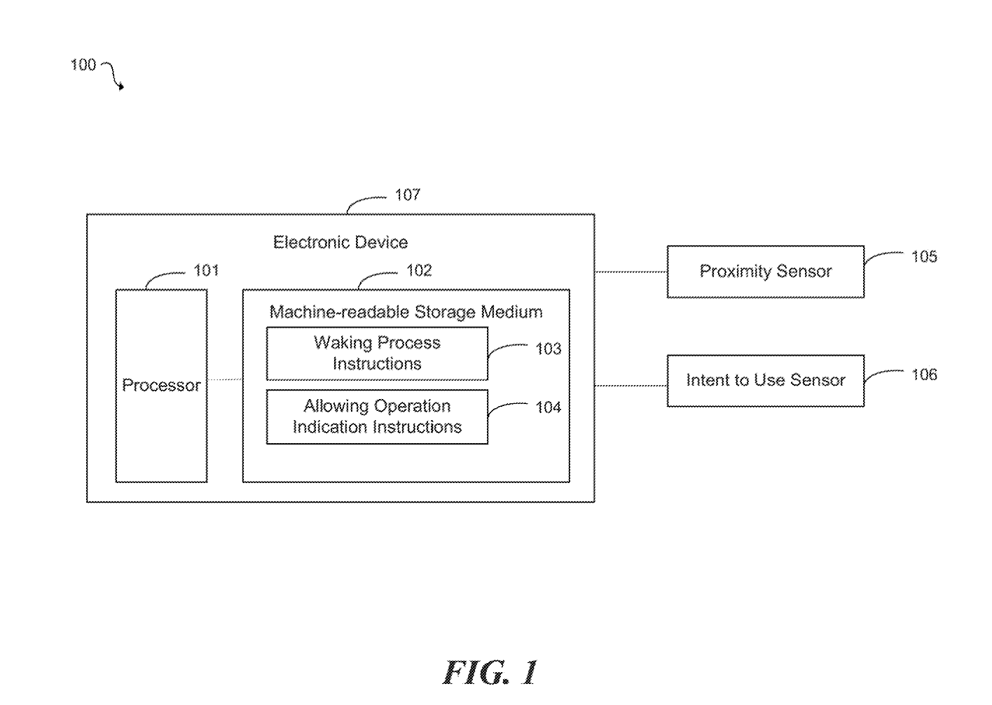

FIG. 1 is a block diagram illustrating one example of a computing system 100. The computing system 100 may include an electronic device 107, such as a personal computer or mobile computing device. The electronic device 107 may be placed in multiple states that involve powering different numbers of components within the electronic device. The electronic device 107 may be in an inactive state, for example, where Random Access Memory (RAM) is powered on, but peripheral devices do not receive power. The electronic device 107 may not be available for use in an inactive state. In one implementation, the electronic device 107 is be placed in a wakeful state where the electronic device wakes while appearing to remain in a more inactive reduced power state, such as a sleep, suspend, or hibernation state. In some implementations, the electronic device 107 may perform a wake process when determined that a potential person is within a particular proximity of the electronic device 107, but suppress an outward indication of the operation of the electronic device until determined that a potential user is attempting or may soon be attempting to use the electronic device 107.

The electronic device 107 may include a processor 101 and a machine-readable storage medium 102. The processor 101 may be any suitable processor, such as a central processing unit (CPU), a semiconductor-based microprocessor, or any other device suitable for retrieval and execution of instructions. In one implementation, the electronic device 107 includes logic instead of or in addition to the processor 101. As an alternative or in addition to fetching, decoding, and executing instructions, the processor 101 may include one or more integrated circuits (ICs) (e.g., an application specific integrated circuit (ASIC)) or other electronic circuits that comprise a plurality of electronic components for performing the functionality described below. In one implementation, the electronic device 107 includes multiple processors. For example, one processor may perform some functionality and another processor may perform other functionality described below.

The computing system 100 may include a proximity sensor 105 and intent to use sensor 106. The proximity sensor 105 may be a sensor for sensing the presence of a person within a particular proximity of the electronic device 107, such as a person within a particular distance of the electronic device 107, within a range of the electronic device 107, or within the same room or other location as the electronic device 107. The proximity sensor 105 may be, for example, a camera, thermal sensor, thermal film sensor, or motion sensor. The proximity sensor 105 may use passive infrared, active infrared, ultrasonic, or video processing technology. In some cases, the monitoring by the proximity sensor 105 may not be noticeable to a human observer and in some cases the monitoring my use little power.

The intent to use sensor 106 may be sense an action by a person indicating intent to use the electronic device 107. For example, the intent to use sensor 106 may sense movement of a peripheral device of the electronic device 107, eye contact with a display or other peripheral device of the electronic device 107, a person within a closer proximity to the electronic device 107, or an input to a button on the electronic device 107.

The proximity sensor 105 and intent to use sensor 106 may communicate directly with the electronic device 107 or via a network. The proximity sensor 105 or intent to use sensor 106 may communicate information to the other sensor that then communicates information to the electronic device 107. The proximity sensor 105 and intent to use sensor 106 may involve multiple components, such as where the proximity sensor 105 includes multiple cameras or where the intent to use sensor 106 includes a sensor for determining typing on a keyboard and a sensor for determining movement of a mouse, either of which may indicate intent to use the electronic device 107. The proximity sensor 105 and intent to use sensor 106 may be located on or within the electronic device 107, on a peripheral device of the electronic device 107, or remotely from the electronic device 107. The proximity sensor 105 and intent to use sensor 106 may include some processing power for analyzing sensor data or may send collected data to the processor 101 for analysis. In some cases, the proximity sensor 105 and the intent to use sensor 106 may involve using a device already on the electronic device 107 for determining proximity and intent to use, such as using a camera within a display bezel or a mouse connected to the electronic device 107.

In some implementations, the proximity sensor 105 and intent to use sensor 106 are combined into a single sensor. For example, a camera may be used to determine that a person is within first proximity of the electronic device and to later determine that a person is within a second proximity of the electronic device indicating intent to use the electronic device 107. In one implementation, the proximity sensor 105 and intent to use sensor 106 are part of the same apparatus, such as where one lens is used for the proximity sensor 105 and another lens is used for the intent to use sensor 106. For example, a thermal film sensor is used including lenses with different focal lengths for focusing thermal radiation produced by a human body. The lens may also include different sensitivities, such as different sensitivities of Polyvinylidene fluoride (PVDF) material composing the lenses. One of the lenses may be used to detect a first proximity to the electronic device and the other lens may be used to detect a second closer proximity to the electronic device.

The machine-readable storage medium 102 may be any suitable machine readable medium, such as an electronic, magnetic, optical, or other physical storage device that stores executable instructions or other data (e.g., a hard disk drive, random access memory, flash memory, etc.). The machine-readable storage medium 102 may be, for example, a computer readable non-transitory medium. The machine-readable storage medium 102 may include instructions executable by the processor 101.

The machine-readable storage medium 102 may include waking process instructions 103 and allowing operation indication instructions 104. Waking process instructions 103 may include instructions for determining that a person is within a particular proximity of the electronic device 107, such as based on information from the proximity sensor 105, and waking the electronic device 107 in response to the determination. For example, waking the electronic device 107 may involve bringing the electronic device 107 into a more active state by powering additional components of the electronic device 107. The wake process may prepare the electronic device 107 for use.

The waking process instructions 103 may include instructions for refraining from exhibiting an outward sign of the operation of the electronic device. For example, a display associated with the electronic device 107 may not be backlit during and after the wake process. Refraining from an exhibiting an outward sign of the operation of the electronic device may make the electronic device 107 to appear to a user to be in a less active state, such as a standby or hibernate state.

The allowing operation indication instructions 104 may include instructions executable by the processor 102 to determine based on information from the intent to use sensor 106 that a person intends to use the electronic device 107 and in response to the determination to allow the operation indication previously not exhibited. For example, upon determining that a person intends to use the electronic device, the display may be backlit. Because the wake process already began and possibly completed, the electronic device 107 may appear to a user to wake more quickly.

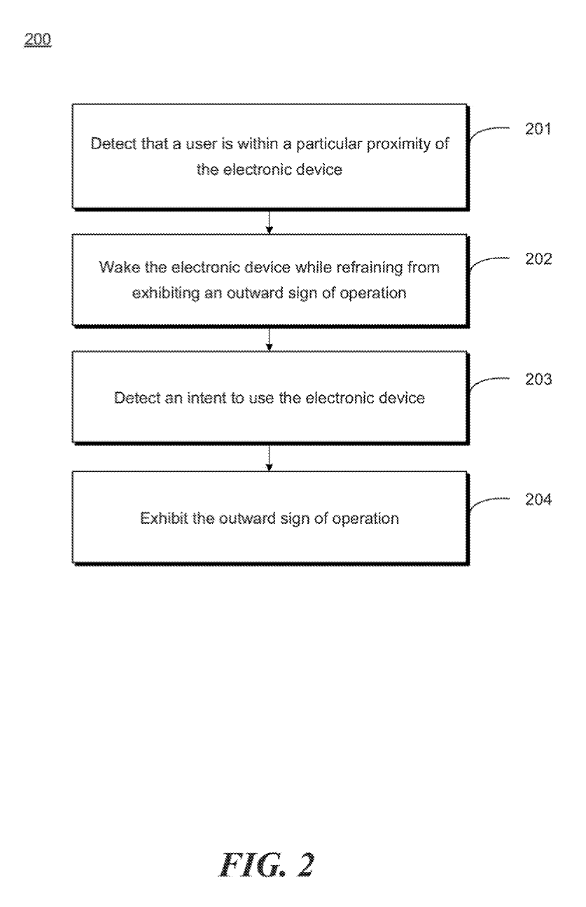

FIG. 2 is a flow chart 200 illustrating one example of a method to wake an electronic device. For example, an electronic device may determine based on sensor data a person is within a particular proximity of the electronic device. When the electronic device determines that the person is within the proximity, such as within the same room as the electronic device, the electronic device may begin a wake process to change states from a reduced power state to a more active state where the electronic device 107 is ready for use. During the wake process, the electronic device may refrain from exhibiting an outward indication of operation that is sometimes exhibited or turned on during the wake process. For example, a display may not be backlit. The electronic device may determine based on sensor data that a person is intending to use the electronic device. In response, the electronic device may exhibit the outward indication previous suppressed or turned off. For example, a display may be backlit in response to determining that a person intends to use the electronic device. The method may be implemented, for example, by the electronic device 107.

Beginning at 201, a processor detects that a person is within a particular proximity of the electronic device. For example, the processor 101 of the electronic device 107 may detect that a person is within a particular proximity of the electronic device 107 based on data from the proximity sensor 105. The processor may receive information from a sensor and determine based on the information that the person is within a particular proximity of the electronic device. In some cases, the processor detecting the location of a person may be a secondary processor for signaling a primary process to wake if a person is detected within a particular proximity of the electronic device.

The sensor may be, for example, a camera, motion sensor, or heat sensor. The sensor may communicate with the processor directly or via a network. The sensor may include additional processing power for determining the proximity of the person based on the collected sensor data or may send the sensor data to the processor for analysis. The sensor may be located on the electronic device containing the processor. For example, a camera may be included in a display bezel, keyboard, or mouse. The sensor may be located across a room, such as a sensor for determining whether a person enters a doorway of a room containing the electronic device. In some cases, the sensor may be used for other purposes, such as a webcam on an electronic device that may be used for video conferencing and sensing a person's proximity to the electronic device.

The processor may detect that a person is a particular distance from the electronic device or in a vicinity of an electronic device. For example, the processor may detect that a person is within a particular proximity of the electronic device if a person is within a range of a heat sensor or within a particular distance range of the electronic device. In some implementations, the processor detects any person within a particular proximity of the electronic device. In some implementations, the processor detects a particular person. For example, a camera sensor may detect that a particular person is within a particular proximity of the electronic device. In one implementation, a setting may indicate the particular proximity. For example, a setting set by a person or manufacturer may indicate that the particular proximity is a particular distance from the electronic device.

Continuing to 202, the processor wakes the electronic device while refraining from exhibiting an outward sign of operation. The processor may be in a sleep, standby or other reduced power mode, and the processor may wake the electronic device. During the reduced power mode, the electronic device may not be ready for use because some components may be unavailable. The wake process may involve, for example, powering on additional components of the electronic device, such as peripheral devices or additional storage or processing components. The processor may refrain from powering on or turn off a particular component that may make the operation of the electronic device discernable by a person.

The processor may refrain from exhibiting an outward sign by, for example, turning down or off a feature that may be activated during the wake process. Refraining from exhibiting the outward sign of the wake process may involve, for example, not backlighting a display, turning off light-emitting diode (LED) indicator lights, turning off speakers, turning down a fan, turning off peripherals or a group of peripherals, and not powering up some internal drives. In some cases, multiple outward signs may be suppressed. Refraining from exhibiting an outward sign may make the electronic device appear to a person to remain in a reduced power mode, such as a sleep or standby mode. For example, a user may not realize that the electronic device has detected the user's presence and started to prepare for use.

In some implementations, an outward sign may be suppressed in addition to the outward sign that the processor refrains from exhibiting. For example, hardware within the electronic device may include a design intended to produce fewer outward indications, such as a fan that is designed to be quieter. As another example, hardware may be designed to perform differently. For example, to prevent the sound of a disk spinning, a DVD-ROM drive may be designed not to check for the presence of a disk when powering on, or a message may be presented to a user when a device is powered down to alert the user to remove a disk in a DVD-ROM drive. In one implementation, components of the electronic device may be designed to exhibit fewer outward indications of operation, and the components may receive an instruction from the processor to run in a mode that exhibits fewer outward indications of operation.

Proceeding to 203, the processor detects intent to use the electronic device. The processor may detect intent to use the electronic device based on information from the sensor detecting proximity or based on information from another sensor. For example, the sensor may be a camera that captures images to determine that a person is within a first proximity and then captures images to determine that the person is within a second closer proximity indicating intent to use the electronic device. The processor may detect intent to use the electronic device based on a second sensor, such as the intent to use sensor 106 from FIG. 1. For example, a heat sensor may detect a person's presence within a particular proximity of the electronic device, and motion detector within a peripheral device may be used to detect intent to use the electronic device. In some cases, the sensors may be components of the electronic device used for other purposes, such as a mouse or webcam. The sensor may communicate directly with the processor or via a network. The sensor may determine the intent to use the electronic device or may provide sensor data to the processor for analysis.

Intent to use the electronic device may be detected in any suitable manner. The intent to use the electronic device may be indicated by a user action suggesting that a person may be about to use an electronic device, such as based on eye contact with a display device, movement or contact with a peripheral device, or a person within a second proximity to the electronic device. For example, an electronic device may begin to wake when a person enters a room and may detect intent to use the electronic device when a person is within a second proximity of the electronic device making eye contact with a display device associated with the electronic device.

In some implementations, the electronic device may return to a reduced power mode, such as a sleep or standby mode, if intent to use the electronic device is not detected within a particular time period after a person is detected within the particular proximity of the electronic device. In some cases, the time period may be set by a user. This may be done to prevent power usage for an awakened electronic device where a person is not using it. The electronic device may then return to a state of waking while refraining from exhibiting the outward sign if proximity of a person is again detected, such as detecting a new person or detecting the originally detected person leaving the proximity and returning to the proximity.

In some implementations, the electronic device may continue to refrain from exhibiting the outward indication of operation despite other processes in addition to the wake process running on the electronic device. Some processes may run as regularly scheduled once the electronic device wakes. For example, a backup process or virus scan process may run after the electronic device wakes, but prior to detecting intent to use the electronic device. The processor may run the additional process while refraining from exhibiting the outward sign of operation, such as running a backup process while a display remains not backlit.

Continuing to 204, the processor exhibits the outward sign of operation. For example, the outward sign of operation that was suppressed may be exhibited once determined that a person intends to use the electronic device. An electronic device may be in a sleep state and begin to wake when a person enters a room. The electronic device may wake with the display and audio off. When a person moves a mouse associated with the electronic device, the display and audio may turn on. The electronic device may appear to wake quickly because the user may be unaware that the wake process was started previously.

In some implementations, the suppressed outward sign is set to turn on as regularly scheduled rather than immediately when intent to use the electronic device is detected. The wake process may be completed or in the process when the processor determines that the person is attempting to use the electronic device. If the wake process is not completed, the outward sign may be exhibited when the wake process involves activating a component responsible for the outward sign. For example, a display may be backlit and show information about the wake process.

Once the wake process is complete and the outward sign is exhibited, the electronic device may be available for use. The process may repeat itself where the person leaves the electronic device. For example, the electronic device may return to an inactive mode.

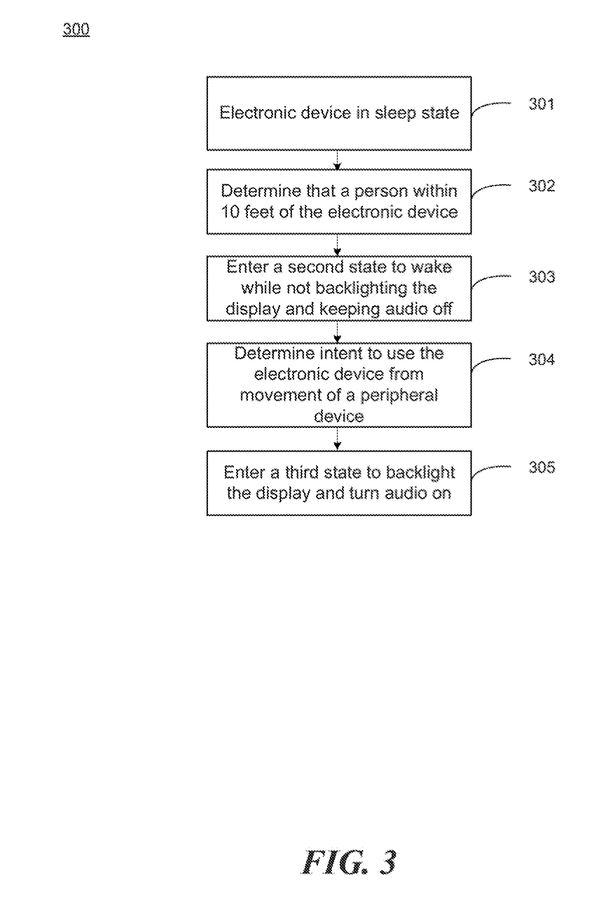

FIG. 3 is a flow chart 300 illustrating one example of waking an electronic device. The electronic device may operate in multiple modes, such as an reduced power mode where the electronic device is in a sleep, suspend or standby state, a second mode where the electronic device operates in an active state while refraining from providing an outward sign of operation, and a third mode where the electronic device operates in an active state and provides an outward sign of operation. The electronic device may switch between modes based on analysis of sensor data.

At 301, an electronic device is in a sleep state. For example, the electronic device may be in a sleep state because the electronic device was not used for a particular amount of time. The sleep state may involve some of the components of the electronic device being powered off so that the electronic device does not consume a large amount of power while not in use.

At 302, the electronic device determines that a person is within ten feet of the electronic device. For example, the electronic device may receive information from a proximity sensor that indicates the distance of the person from the electronic device. The electronic device may receive information about the distance of the person from the electronic device or information indicating that a person is within a ten foot range of the electronic device.

At 303, the electronic device enters a second state where the electronic device wakes while not backlighting the display and keeping the audio speakers turned off. For example, the electronic device may power additional components and prepare for use. The electronic device may execute software related to use of the electronic device.

At 304, the electronic device determines intent to use the electronic device from movement of a peripheral device. For example, a mouse may be moved. A processor within the electronic device may determine that the movement of a peripheral device indicates intent to use the electronic device.

At 305, the electronic device enters a third state where the display is backlit and the audio is turned on. The outward signs previously turned off may be turned on to provide greater functionality to the electronic device now that a person is intending to use the electronic device. The electronic device may be ready for use.

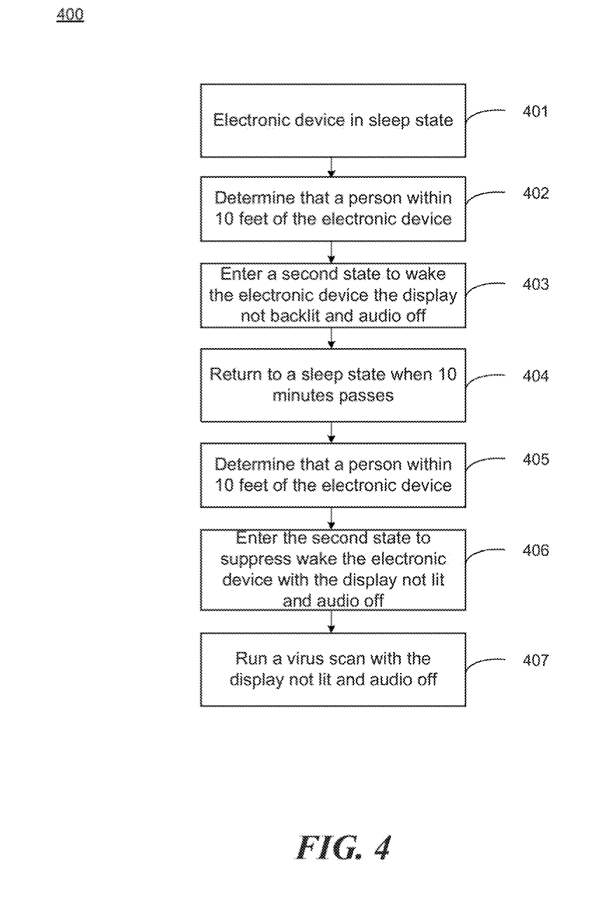

FIG. 4 is a flow chart illustrating one example of waking an electronic device. The electronic device may operate within multiple states, such as a reduced power state, a wakeful state where the electronic is awake but suppressing some signs of being awake, and an active state where the electronic device is awake and ready for use. The electronic device may transition between the states. For example, the electronic device may go from a sleep state to a wakeful state and back to a sleep state again or from a sleep state to a wakeful state to an active state and back to a sleep state again. The electronic device may remain in a particular state as other processes are executed on the electronic device.

At 401, are electronic device is in a steep state. The electronic device may be in a sleep state because of no use for a particular time period or due to a user placing the electronic device in a sleep state. In the sleep state, the electronic device Random Access Memory (RAM) may continue to run while other components are turned off to conserve power.

At 402, the electronic device determines that a person is within ten feet of the electronic device. For example, the electronic device may analyze information received from a earners or other sensor. At 403, the electronic device enters a second state to wake the electronic device with the display not backlit and audio off. For example, the electronic device may begin powering other components of the electronic device. The electronic device may run other processes to begin using a display and speakers while keeping the audio on mute and the display not lit.

At 404, the electronic device returns to a sleep state once ten minutes have passed since the electronic device was awakened. The electronic device may include a setting indicating an amount of time without use after a partial wake process that indicates that the electronic device should return to a sleep state to conserve power. For example, the electronic device may go into a sleep state thirty minutes after not being used or ten minutes after entering a waking state where intent to use the electronic device was not detected.

At 405, the electronic device determines that a person has moved within ten feet of the electronic device. For example, the proximity sensor may determine that a person is again within ten feet of the electronic device because the person that was within ten feet of the electronic device left the ten feet radius and came back or another person moved within ten feet of the electronic device. At 406, the electronic device again enters the first state to wake the electronic device with the display not backlit and the audio off in response to detecting a person within ten feet of the electronic device.

At 407, the electronic device runs a virus with the display not backlit and the audio off. The electronic device may run scheduled processes while remaining to appear to be in an inactive mode. This may prevent the electronic device from appearing to instantly awaken when another process executes.

Waking an electronic device based on a proximity of a person to the electronic device and making the electronic device appear to remain in an inactive reduced power state until determined that a person intends to use the electronic device may make an electronic device appear to more quickly transition from an inactive to an active state. The electronic device may appear to better accommodate a user due to the faster activation time.

1. A computing system, comprising:
at least one sensor to sense the presence of a person and to sense intent to use an electronic device; and
the electronic device 107 including a processor 101 to:
start a wake process of the electronic device when determined based on information from the sensor that a person is within a particular proximity of the electronic device 107,
wherein starting the wake process comprises repressing an outward indication of the operation of the electronic device 107; and
allow the outward indication of operation of the electronic device 107 when determined based on information from the sensor intent to use the electronic device 107.

2. The computing system of claim 1, wherein the outward indication of operation of the electronic device 107 comprises at least one of a visual or audio indication.

3. The computing system of claim 1, wherein determining intent to use the electronic device 107 comprises determining at least one of:
movement of a peripheral device associated with the electronic device 107;
eye contact with a display associated with the electronic device 107; and
presence of a person within a second proximity of the electronic device 107 of a distance less than the first proximity.

4. The computing system of claim 1, wherein the processor 101 further enters a reduced power mode where the processor 101 does not determine within a particular amount of time intent to use the electronic device 107 after sensing presence of a person within proximity of the electronic device 107.

5. A method for waking an electronic device 107, comprising:
detecting that a person is within a particular proximity of the electronic device 107;
waking, by a processor 101, the electronic device 107 while refraining from exhibiting an outward sign of operation;
detecting intent to use the electronic device 107; and
exhibiting, by the processor 101, outward sign of operation.

6. The method of claim 5, further comprising entering a reduced power mode after waking where an action indicating intent to use is not detected within a particular time period.

7. The method of claim 5, wherein detecting intent to use the electronic device 107 comprises detecting at least one of:
movement of a peripheral device associated with the electronic device 107;
eye contact with a display associated with the electronic device 107; and
presence of a person within a second proximity of the electronic device 107 closer to the electronic device 107.

8. The method of claim 5, wherein outward signs of operation of the electronic device 107 comprise at least one of visual and audio sighs.

9. The method of claim 5, wherein refraining from exhibiting outward visual signs of operation comprise turning off or down at least one of: a light-emitting diode indicator, a display backlight, a peripheral device, a fan, and an internal drive.

10. The method of 5, wherein detecting a person is within a particular proximity comprises detecting based on information from a first sensor, and wherein detecting intent to use the electronic device 107 comprises detecting based on information from a second sensor.

11. The method of claim 5, further comprising refraining from exhibiting an outward sign of operation of the electronic device 107 where a second process begins before detection of intent to use the electronic device 107.

12. A machine-readable non-transitory storage medium 102 comprising instructions executable by a processor 101 to:
determine based on information from a sensor that a person is within a particular proximity of an electronic device 107 associated with the processor 101;
enter a first state, wherein an outward indication of operation of the electronic device 107 is suppressed;
wake the electronic device 107;
determine based on information from a sensor intent to use the electronic device 107; and
enter a second state, wherein the outward indication of operation of the electronic device 107 is not suppressed.

13. The machine-readable non-transitory storage medium 102 of claim 12, wherein instructions to determine intent to use the electronic device 107 comprise instructions to determine the occurrence of at least one of:
movement of a peripheral device associated with the electronic device 107;
eye contact with a display associated with the electronic device 107; and
presence of a person within a second proximity of the electronic device 107 closer the electronic device 107 than the first proximity.

14. The machine-readable non-transitory storage medium 102 of claim 12, wherein the outward indication comprises a visual or audio indication.

15. The machine-readable non-transitory storage medium of claim 12, further comprising instructions to:
start a second process on the electronic device 107;
suppress the outward indication of operation of the electronic device 107 where the electronic device 107 is in the first state; and
exhibit the outward indication of operation of the electronic device 107 where the electronic device 107 is in the second state.
